(19) United States
(12) Patent Application Publication
(10) Pub. No.: US 2025/0026566 A1
(43) Pub. Date: Jan. 23, 2025

(54) CAMERA UNIT

(71) Applicant: OCADO INNOVATION LIMITED, Hatfield, Hertfordshire (GB)

(72) Inventors: David SOBEY, Hatfield, Hertfordshire (GB); Davide LORA, Hatfield, Hertfordshire (GB)

(73) Assignee: OCADO INNOVATION LIMITED, Hatfield, Hertfordshire (GB)

(21) Appl. No.: 18/711,206

(22) PCT Filed: Nov. 17, 2022
(86) PCT No.: PCT/EP2022/082343

§ 371 Date: May 17, 2024

(30) Foreign Application Priority Data
Nov. 17, 2021 (GB) 2116558.4
Jan. 21, 2022 (GB) 2200782.7

(51) Int. Cl. B65G 1/04

(52) U.S. Cl. CPC B65G 1/0478; B65G 1/0464; B65G 2203/041; B65G 2203/044

(57) ABSTRACT

A camera unit is provided for use with a cubic automated storage and retrieval system. The camera unit is configured to operate on a grid of the storage and retrieval system such that is received within a single grid cell of the storage and retrieval system. The camera unit is mounted to the framework of the storage and retrieval system and includes a camera array having one or more cameras. The camera unit is arranged such that the camera array may view one or more picking station located on the grid of the storage and retrieval system.

### TECHNICAL FIELD

The present disclosure relates generally to the field of automated storage and retrieval systems for use in warehouses and/or fulfilment centres and more specifically to a camera unit for a robotic picking station which may be used in such storage and retrieval systems.

### BACKGROUND

Online retail businesses selling multiple product lines, such as online grocers and supermarkets, require systems that are able to store tens or even hundreds of thousands of different product lines. The use of single-product stacks in such cases can be impractical, since a very large floor area would be required to accommodate all of the stacks required. Furthermore, it can be desirable only to store small quantities of some items, such as perishables or infrequently-ordered goods, making single-product stacks an inefficient solution.

International patent application WO 98/049075A (Autostore), the contents of which are incorporated herein by reference, describes a system in which multi-product stacks of containers are arranged within a frame structure.

PCT Publication No. WO2015/185628A (Ocado) describes a further known storage and fulfilment system in which stacks of bins or containers are arranged within a framework structure. The bins or containers are accessed by load handling devices operative on tracks located on the top of the frame structure. The load handling devices lift bins or containers out from the stacks, multiple load handling devices co-operating to access bins or containers located in the lowest positions of the stack. A system of this type is illustrated schematically in FIGS. 1 to 4 of the accompanying drawings.

FIG. 1 illustrates an automated storage and retrieval structure 1 comprising upright members 3 and horizontal members 5, 7 which are supported by the upright members 3. The horizontal members 5 extend parallel to one another and the illustrated x-axis. The horizontal members 7 extend parallel to one another and the illustrated y-axis, and transversely to the horizontal members 5. The upright members 3 extend parallel to one another and the illustrated z-axis, and transversely to the horizontal members 5, 7. The horizontal members 5, 7 form a grid pattern defining a plurality of grid cells. In the illustrated example, containers 9 are arranged in stacks 11 beneath the grid cells defined by the grid pattern, one stack 11 of containers 9 per grid cell.

FIG. 2 shows a large-scale plan view of a section of track structure 13 forming part of the storage structure 1 illustrated in FIG. 1 and located on top of the horizontal members 5, 7 of the storage structure 1 illustrated in FIG. 1. The track structure 13 may be provided by the horizontal members 5, 7 themselves (e.g. formed in or on the surfaces of the horizontal members 5, 7) or by one or more additional components mounted on top of the horizontal members 5, 7. The illustrated track structure 13 comprises x-direction tracks 17 and y-direction tracks 19, i.e. a first set of tracks 17 which extend in the x-direction and a second set of tracks 19 which extend in the y-direction, transverse to the tracks 17 in the first set of tracks 17. The tracks 17, 19 define apertures 15 at the centres of the grid cells. The apertures 15 are sized to allow containers 9 located beneath the grid cells to be lifted and lowered through the apertures 15. The x-direction tracks 17 are provided in pairs separated by channels 21, and the y-direction tracks 19 are provided in pairs separated by channels 23. Other arrangements of track structure may also be possible.

FIG. 3 shows a plurality of load-handling devices 31 moving on top of the storage structure 1 illustrated in FIG. 1. The load-handling devices 31, which may also be referred to as robots 31 or bots 31, are provided with sets of wheels to engage with corresponding x- or y-direction tracks 17, 19 to enable the bots 31 to travel across the track structure 13 and reach specific grid cells. The illustrated pairs of tracks 17, 19 separated by channels 21, 23 allow bots 31 to occupy (or pass one another on) neighbouring grid cells without colliding with one another.

As illustrated in detail in FIG. 4, a bot 31 comprises a body 33 in or on which are mounted one or more components which enable the bot 31 to perform its intended functions. These functions may include moving across the storage structure 1 on the track structure 13 and raising or lowering containers 9 (e.g. from or to stacks 11) so that the bot 31 can retrieve or deposit containers 9 in specific locations defined by the grid pattern.

The illustrated bot 31 comprises first and second sets of wheels 35, 37 which are mounted on the body 33 of the bot 31 and enable the bot 31 to move in the x- and y-directions along the tracks 17 and 19, respectively. In particular, two wheels 35 are provided on the shorter side of the bot 31 visible FIG. 4, and a further two wheels 35 are provided on the opposite shorter side of the bot 31 (side and further two wheels 35 not visible in FIG. 4). The wheels 35 engage with tracks 17 and are rotatably mounted on the body 33 of the bot 31 to allow the bot 31 to move along the tracks 17. Analogously, two wheels 37 are provided on the longer side of the bot 31 visible in FIG. 4, and a further two wheels 37 are provided on the opposite longer side of the bot 31 (side and further two wheels 37 not visible in FIG. 4). The wheels 37 engage with tracks 19 and are rotatably mounted on the body 33 of the bot 31 to allow the bot 31 to move along the tracks 19.

The bot 31 also comprises container-lifting means 39 configured to raise and lower containers 9. The illustrated container-lifting means 39 comprises four tapes or reels 41 which are connected at their lower ends to a container-engaging assembly 43. The container-engaging assembly 43 comprises engaging means (which may, for example, be provided at the corners of the assembly 43, in the vicinity of the tapes 41) configured to engage with features of the containers 9. For instance, the containers 9 may be provided with one or more apertures in their upper sides with which the engaging means can engage. Alternatively or additionally, the engaging means may be configured to hook under the rims or lips of the containers 9, and/or to clamp or grasp the containers 9. The tapes 41 may be wound up or down to raise or lower the container-engaging assembly, as required. One or more motors or other means may be provided to effect or control the winding up or down of the tapes 41.

As can be seen in FIG. 5, the body 33 of the illustrated bot 31 has an upper portion 45 and a lower portion 47. The upper portion 45 is configured to house one or more operation components (not shown). The lower portion 47 is arranged beneath the upper portion 45. The lower portion 47 comprises a container-receiving space or cavity for accommodating at least part of a container 9 that has been raised by the container-lifting means 39. The container-receiving space is sized such that enough of a container 9 can fit inside the cavity to enable the bot 31 to move across the track structure 13 on top of storage structure 1 without the underside of the container 9 catching on the track structure 13 or another part of the storage structure 1. When the bot 31 has reached its intended destination, the container-lifting means 39 controls the tapes 41 to lower the container-gripping assembly 43 and the corresponding container 9 out of the cavity in the lower portion 47 and into the intended position. The intended position may be a stack 11 of containers 9 or an egress point of the storage structure 1 (or an ingress point of the storage structure 1 if the bot 31 has moved to collect a container 9 for storage in the storage structure 1). Although in the illustrated example the upper and lower portions 45, 47 are separated by a physical divider, in other embodiments, the upper and lower portions 45, 47 may not be physically divided by a specific component or part of the body 33 of the bot 31.

In some embodiments, the container-receiving space of the bot 31 may not be within the body 33 of the bot 31. For example, in some embodiments, the container-receiving space may be adjacent to the body 33 of the bot 31, e.g. in a cantilever arrangement with the weight of the body 33 of the bot 31 counterbalancing the weight of the container to be lifted. In such embodiments, a frame or arms of the container-lifting means 39 may protrude horizontally from the body 33 of the bot 31, and the tapes/reels 41 may be arranged at respective locations on the protruding frame/arms and configured to be raised and lowered from those locations to raise and lower a container into the container-receiving space adjacent to the body 33. The height at which the frame/arms is/are mounted on and protrude(s) from the body 33 of the bot 31 may be chosen to provide a desired effect. For example, it may be preferable for the frame/arms to protrude at a high level on the body 33 of the bot 31 to allow a larger container (or a plurality of containers) to be raised into the container-receiving space beneath the frame/arms. Alternatively, the frame/arms may be arranged to protrude lower down the body 33 (but still high enough to accommodate at least one container between the frame/arms and the track structure 13) to keep the centre of mass of the bot 31 lower when the bot 31 is loaded with a container.

To enable the bot 31 to move on the different wheels 35, 37 in the first and second directions, the bot 31 includes a wheel-positioning mechanism for selectively engaging either the first set of wheels 35 with the first set of tracks 17 or the second set of wheels 37 with the second set of tracks 19. The wheel-positioning mechanism is configured to raise and lower the first set of wheels 35 and/or the second set of wheels 37 relative to the body 33, thereby enabling the load-handling device 31 to selectively move in either the first direction or the second direction across the tracks 17, 19 of the storage structure 1.

The wheel-positioning mechanism may include one or more linear actuators, rotary components or other means for raising and lowering at least one set of wheels 35, 37 relative to the body 33 of the bot 31 to bring the at least one set of wheels 35, 37 out of and into contact with the tracks 17, 19. In some examples, only one set of wheels is configured to be raised and lowered, and the act of lowering the one set of wheels may effectively lift the other set of wheels clear of the corresponding tracks while the act of raising the one set of wheels may effectively lower the other set of wheels into contact with the corresponding tracks. In other examples, both sets of wheels may be raised and lowered, advantageously meaning that the body 33 of the bot 31 stays substantially at the same height and therefore the weight of the body 33 and the components mounted thereon does not need to be lifted and lowered by.

The system described with reference to FIGS. 1 to 4 has many advantages and is suitable for a wide range of storage and retrieval operations. In particular, it allows very dense storage of product, and it provides a very economical way of storing a huge range of different items in the containers 9, while allowing reasonably economical access to all of the containers when required for picking.

As shown in FIG. 3, a plurality of identical load handling devices 31 are provided, so that each load handling device 31 can operate simultaneously to increase the throughput of the system. The system illustrated in FIG. 3 may include specific locations, known as ports, at which containers can be transferred into or out of the system. An additional conveyor system (not shown) is associated with each port, so that containers transported to a port by a load handling device 31 can be transferred to another location by the conveyor system, for example to a picking station (not shown). Similarly, containers can be moved by the conveyor system to a port from an external location, for example to a container-filling station (not shown), and transported to a stack 12 by the load handling devices 30 to replenish the stock in the system.

Each load handling device 31 can lift and move one containers at a time. If it is necessary to retrieve a container (“target container”) that is not located on the top of a stack, then the overlying containers (“non-target containers”) must first be moved to allow access to the target containers. This is achieved in an operation referred to hereafter as “digging”. During a digging operation, one of the load handling devices sequentially lifts each non-target container from the stack containing the target container and places it in a vacant position within another stack. The target container can then be accessed by the load handling device and moved to a port for further transportation.

Each of the load handling devices is under the control of a central computer. Each individual container in the system is tracked, so that the appropriate containers can be retrieved, transported and replaced as necessary. For example, during a digging operation, the locations of each of the non-target containers is logged, so that the non-target containers can be tracked.

The system described with reference to FIGS. 1 to 5 has many advantages and is suitable for a wide range of storage and retrieval operations. In particular, it allows very dense storage of product, and it provides a very economical way of storing a huge range of different items in the containers, while allowing reasonably economical access to all of the containers when required for picking.

### SUMMARY

In general terms, the disclosure introduces a camera unit which can be used within an automated storage and retrieval system, such that the camera unit occupies a single grid space of the system.

According to a first aspect of the present disclosure there is provided a camera unit configured to be mounted to a grid-based storage system, the camera unit comprising: a mount for mounting the camera unit to the storage system, such that the camera unit is received within a grid cell of the storage system; a camera array comprising one or more cameras; and a camera array support, a first end of which is coupled to the mount and a second end of which is coupled to the camera array.

The camera unit may further comprise a computing device comprising one or more processors and one or more data storage units, the computing device being configured, in use, to process images captured by the camera array. Alternatively, or in addition, the camera unit may be communicably connected to a remote computing device, the remote computing device comprising one or more processors and one or more data storage units and being configured, in use, to process images captured by the camera array.

The camera array comprise one or more lighting elements. One or more of the cameras may be configured to be rotated or moved within the camera array. Alternatively, or in addition, the camera array may rotate or move relative to the camera array support. The camera unit may be configured to be retracted below the surface of the grid.

The mount may be connected to one or more framework members of the storage system. The mount may be received below a top surface of the storage system. The mount may be connected to one or more vertical framework members of the storage system and/or one or more horizontal framework members of the storage system. The camera unit may comprise one or more mounts connected to one or more framework members of the storage system below the top surface of the storage system. The mount may be connected to a floor of the storage system.

According to a second aspect of the present disclosure there is provided a storage system comprising: a first set of tracks extending in a first direction; a second set of tracks extending in a second direction transverse to the first direction, to form a grid comprising a plurality of grid cells, a framework structure on which the first set of tracks and the second set of tracks are received such that a stack of containers may be stored below each of the plurality of grid cells; and one or more camera units as described above.

The storage system may comprise a plurality of load-handling devices for lifting and moving containers stacked in stacks within the storage system, each of the load-handling devices being configured to move on the tracks above the stacks of containers. The storage system may comprise one or more regions in which the stacks beneath the grid have a reduced height and where one or more camera units are located above one of the regions. One or more of the camera units may be configured such that it can be lowered beneath the grid surface.

The storage system may further comprise one or more robotic picking stations received on the surface of the grid. A camera unit may be configured to view one or more of plurality of robotic picking stations. A robotic picking station may be received within a single grid cell of the storage system; each of the grid cells surrounding the grid cell comprising the robotic picking station may be designated as a picking location; and a camera unit may be configured to view each of the picking locations. The camera unit may comprise a plurality of cameras such that there is one camera for each picking location.

### BRIEF DESCRIPTION OF THE DRAWINGS

Embodiments of the disclosure will now be described by way of example only with reference to the accompanying drawings, in which like reference numbers designate the same or corresponding parts, and in which:

FIG. 1 shows a schematic depiction of an automated storage and retrieval structure;

FIG. 2 shows a schematic depiction of s plan view of a section of track structure forming part of the storage structure of FIG. 1;

FIG. 3 shows a schematic depiction of a plurality of load-handling devices moving on top of the storage structure of FIG. 1;

FIGS. 4 and 5 show a schematic depiction of a load handling device interacting with a container;

FIGS. 6 and 7 show a schematic depiction of a robotic picking station;

FIG. 8 shows a schematic depiction of a part of a storage system comprising a recess formed under the grid;

FIG. 9 shows a schematic depiction of an overhead view of the grid of a storage system similar to that described above;

FIG. 10 shows a schematic depiction of a further example of a camera array according to the present disclosure

FIG. 11 shows a schematic depiction of a part of a storage system similar to that of FIG. 8

FIG. 12 shows a schematic depiction of a part of a storage system similar to that of FIG. 8; and

FIG. 13 shows a schematic depiction of a computer device.

### DETAILED DESCRIPTION OF EMBODIMENTS

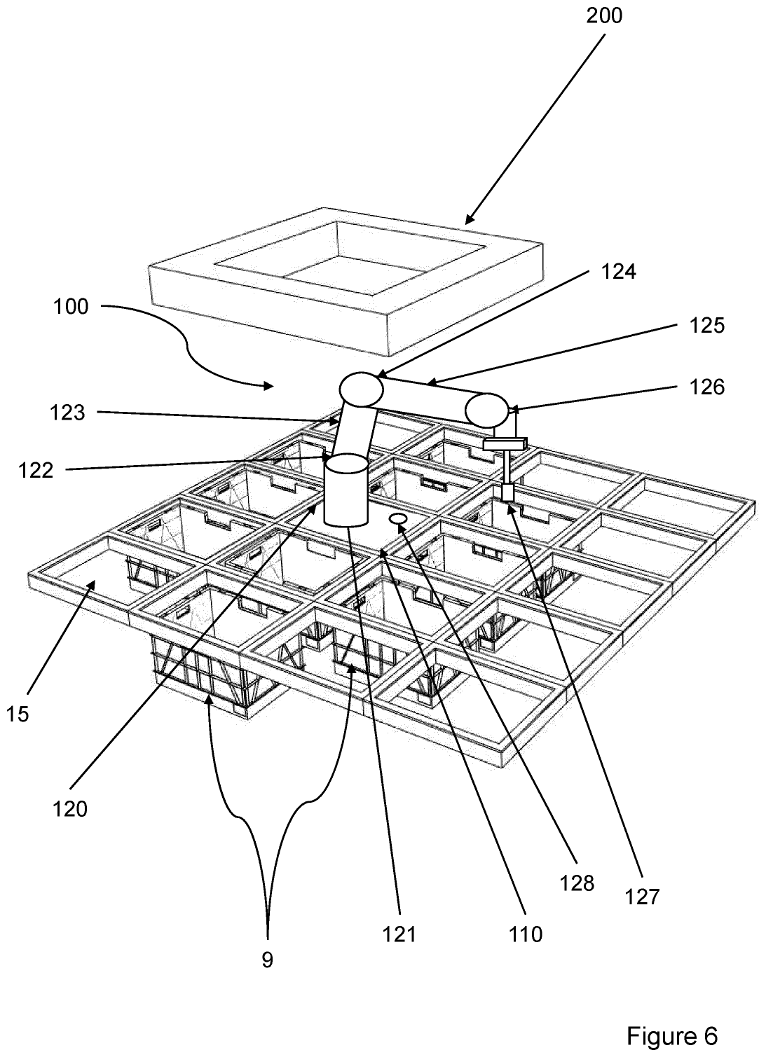

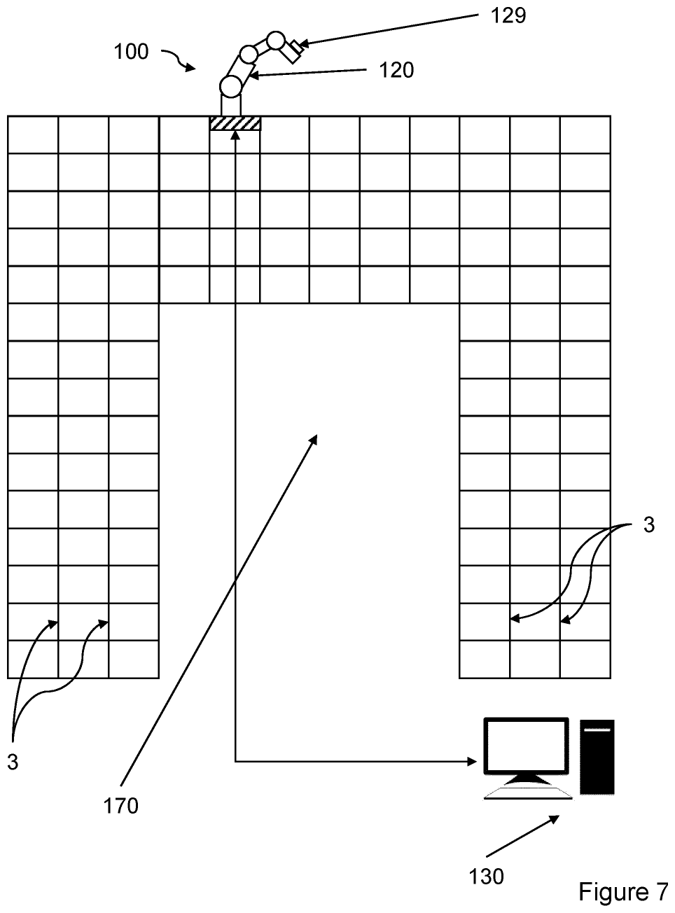

FIGS. 6 and 7 show a schematic depiction of a robotic picking station 100, which comprises a plinth 110 upon which a robotic arm 120 is received. The plinth 110 is of a size and shape such that it may be received within the aperture 15 of a grid cell formed by intersecting horizontal members 5, 7. The plinth may be substantially rectangular in shape. The plinth is connected to the framework of the storage system such that the robotic arm is mounted on the storage system. For example, the plinth may be connected to one or more of the upright members 3 of the storage system. Alternatively, the plinth may be connected to one or more of the horizontal members 5, 7 of the storage system. The plinth may be connected to one or more of the upright members 3 and one or more of the horizontal members 5, 7 of the storage system. The surface of the plinth may extend across substantially the entirety of the aperture of the grid cell in which it is received. This will reduce the risk that a dropped product may fall into the storage system, potentially interfering with the operation of the storage system. Alternatively, the surface of the plinth may only partially extend across the area of the grid cell in which it is received.

In an alternative, a mount may be used to connect the robotic arm to the framework of the grid structure. One or more mount members may mount the robotic arm, for example the base of the robotic arm, to one or more members of the storage system. The robotic arm may be mounted to: one or more upright members of the storage system; one or more horizontal members of the storage system; or one or more upright and one or more horizontal members of the storage system. The mount may be configurable such that the picking station may be retracted below the level of the grid (see below).

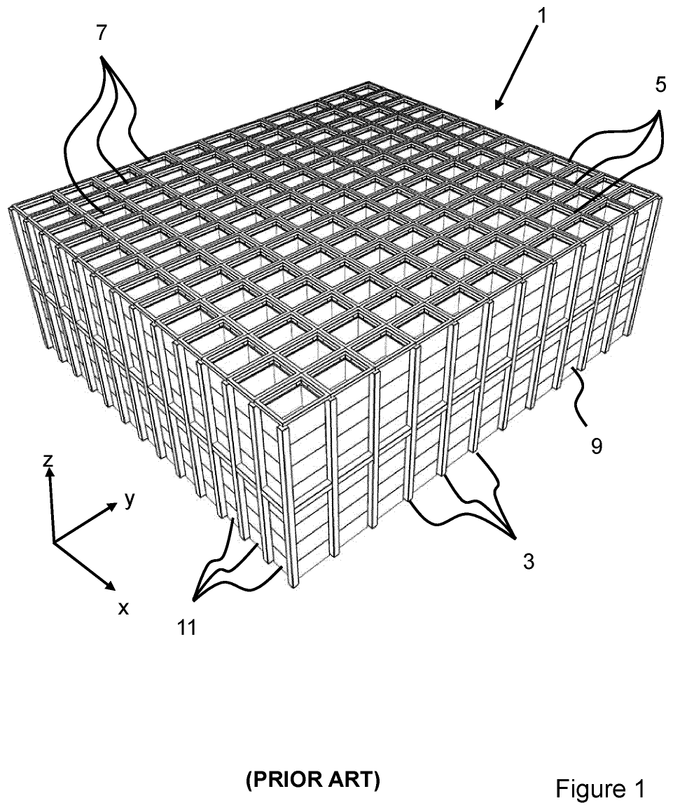

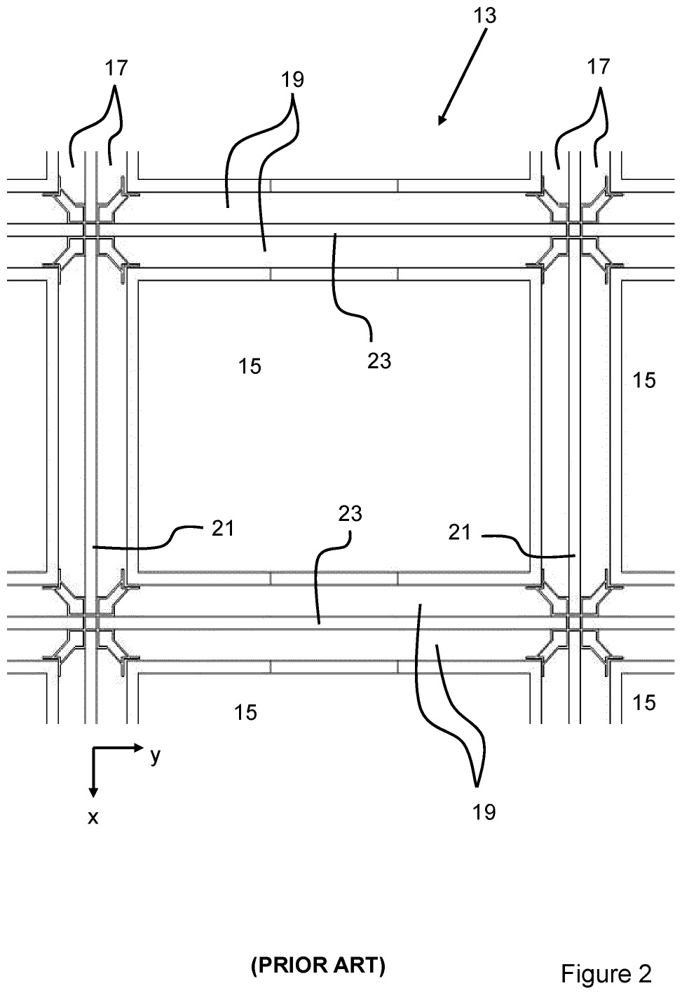

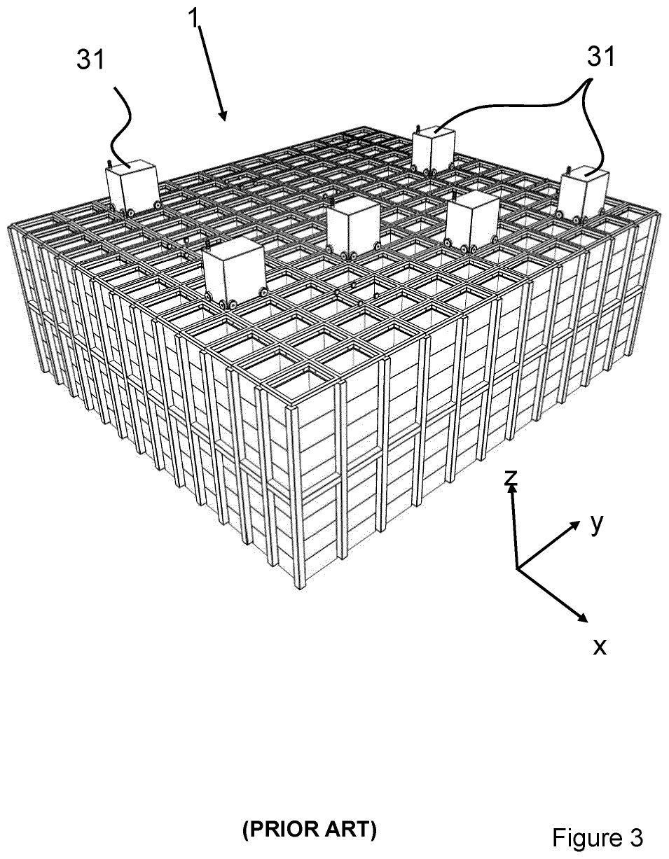

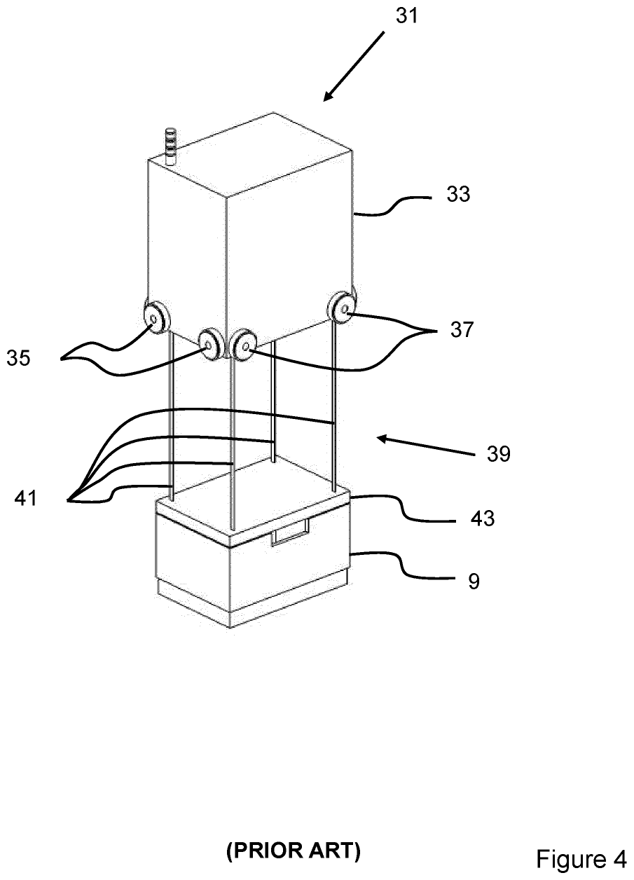

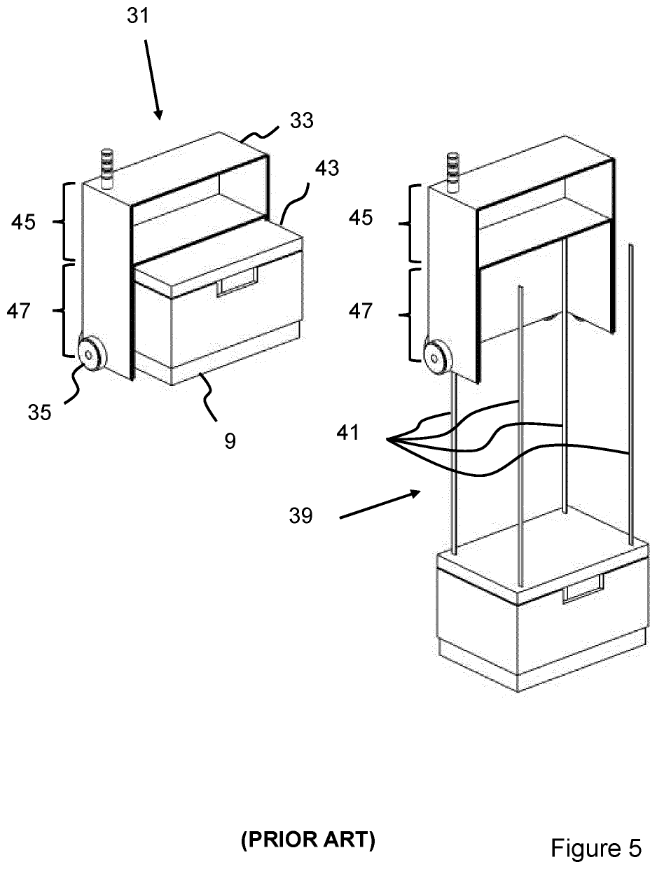

The robotic arm 120 comprises a base 121, first joint 122, upper arm portion 123, second joint 124, lower arm portion 125, third joint 126 and end effector 127. The base 121 extends substantially vertically from the plinth and is connected to the upper arm portion by the first joint, or shoulder. The upper arm portion is connected to the lower arm portion by the second joint, or elbow. The lower arm portion is connected to the end effector by the third joint, or wrist. The first joint, the second joint and the third joint may be selectively actuated such that the end effector may be moved along one or more of the x-axis, the y-axis and the z-axis (see FIG. 1). This means that the end effector may be moved into a first container such that it can be activated to engage with a product stored within that container. The product may then be lifted from the first container and the end effector may then be moved to a second container. Once the product is appropriately placed within the second container then the end effector may be deactivated such that the product is deposited into the second container. The end effector may comprise a suction device, a pair of opposed grippers, a plurality of fingers or other known effectors which can be used to grip and lift products. It should be understood that the specific configuration of the robotic arm shown in FIG. 6 is purely exemplary and that robotic arms of other configurations could be used. For example, the robotic arm may comprise a greater or lesser number of portions and joints.

The picking station may further comprise an optical sensor 128, which may be located on the upper surface of the plinth 120. The optical sensor may be used in the identification of products in the picking process. The picking station may comprise a plurality of optical sensors. In one example, the picking station may comprise four optical scanners, with one optical scanner being located at, or near to, each corner of the plinth. The or each optical scanner may comprise a barcode reader. The picking station may further comprise a camera array (see below), which is arranged so as to be able to view the area in which the end effector will operate.

The picking station may further comprise one or more cameras mounted on the robotic arm. A camera 129 (see FIG. 7) may be mounted on, or near to, the end effector. A camera may be mounted on or near the wrist. In addition, or alternatively, a camera may be mounted on or near to the elbow of the robotic arm. The use of a camera, or cameras, mounted on the robotic arm may be in addition to the camera array or as an alternative. The or each camera may be provided with lighting elements to illuminate the interior of a container when an item is being picked or deposited. One or more cameras may be located elsewhere on the picking station. For example, a camera may be used as a barcode scanner.

The picking station may further comprise a computer device 130, which may be used to control the movement of the robotic arm and the activation of the end effector. Images from the camera array may be fed to the computer device for processing to assist in the identification and/or grasping of items stored in containers. The computer device may be located beneath the plinth of the picking station. The picking station may, in an alternative (and as shown in FIG. 7), be connected to a remote computer device, for example by a wired Ethernet connection (or other network connection). Such a remote computer device may be used to control a plurality of picking stations. The remote computer device may be the central computer used to control the load handling devices. In a further alternative, a cloud computing platform may be used to control the picking stations within the storage system. A computer device may be located at or near to the camera array such that images captured by the camera array can be processed and then transmitted to an associated picking station. A computer device located at or near to the camera array may perform a degree of image pre-processing with further image processing being performed at the picking station.

FIG. 6 shows a number of containers arranged near to the picking station, which provide a plurality of picking locations. In this example, the picking locations comprise the eight containers which are immediately adjacent to the picking station and two further containers. These two further containers are located in the middle space of the long edge of the array of the eight containers adjacent to the picking station. These ten containers are the containers that the end effector can reach, such that products can be picked from or to one of the containers. It should be understood that the example shown in FIG. 6 is not limiting and that the exact number and siting of the picking locations may be varied and will be limited by the movement and range of the robotic arm. In an alternative arrangement, each of the picking stations may be surrounded by eight picking locations, such that the picking station and the associated picking locations form a 3×3 block of grid locations.

FIG. 7 shows a schematic depiction of a part of the storage system shown in FIG. 1. Conventionally, the storage system may comprise a region where the stacks of the storage system are reduced in height, that is each of the stacks in the reduced height region can accommodate fewer containers than the stacks in the rest of the storage system. A recess 170 is formed underneath the region of the storage system which comprises the reduced height stacks. Conventionally, a picking aisle may be located within this recessed area, with lifting and other transfer mechanisms provided to bring storage containers down from the grid surface for picking at manual picking stations and to then return the storage containers to the grid once the picking is complete. Although FIG. 7 shows that the reduced height region of the stacks may comprise several layers of containers, it should be understood that the reduced height region may comprise a single layer of containers. The manual picking stations, and other associated equipment, may be located on a mezzanine floor underneath the reduced height region to make more efficient use of space beneath the grid. A picking station 100 may be located on the grid such that it is above the recess 170.

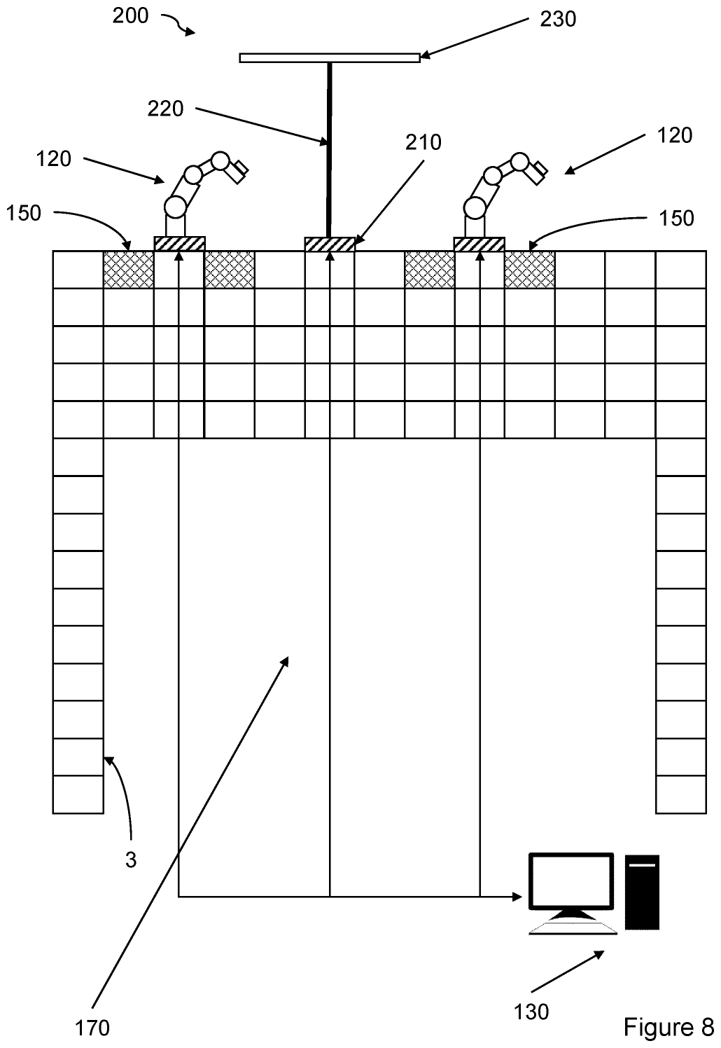

FIG. 8 shows a schematic depiction of a part of a storage system similar to that described above with reference to FIG. 1, which comprises a recess 170 formed under the grid. Mounted on the grid are two robotic picking stations 120, the structure and operation of which has been described above with reference to FIGS. 6 & 7. Also mounted on the grid are one or more camera units 200. Each camera unit 200 comprises a plinth 210, camera array support 220 and camera array 230. The camera plinth 210 may be similar to the plinth 110 upon which a robotic arm 120 is received. The camera unit is received within a single grid cell, with the camera plinth 210 having a size and shape such that it may be received within the aperture 15 of a grid cell formed by intersecting horizontal members 5, 7. The camera plinth may be substantially rectangular in shape. The camera plinth is connected to the framework of the storage system such that the camera array is mounted above the storage system. For example, the camera plinth may be connected to one or more of the upright members 3 of the storage system. Alternatively, the camera plinth may be connected to one or more of the horizontal members 5, 7 of the storage system. The camera plinth may be connected to one or more of the upright members 3 and one or more of the horizontal members 5, 7 of the storage system. The surface of the camera plinth may extend across substantially the entirety of the aperture of the grid cell in which it is received. Alternatively, the surface of the plinth may only partially extend across the area of the grid cell in which it is received.

Alternatively, the camera unit may be connected to the framework of the storage system via a mount such that the camera unit can be retracted below the surface of the gird, for example for maintenance activities. In such a case the camera array support may be telescopic and/or the camera array may be foldable to assist in the retraction of the camera unit.

The camera array support 210 is mounted to the camera plinth such that it supports the camera array above the surface of the grid. Clearly, the camera array will need to be at a height that enables bots to pass underneath. Preferably, the camera array will be high enough to allow a technician present on the grid to walk underneath it. In one example, camera may be lowered from its operational height to a lower level to enable a technician to perform maintenance operations on the camera array, or a camera which is comprised within the camera array. The technician may be standing on the surface of the grid, or on a vehicle which can travel on the tracks of the grid. By reducing the height of the camera a technician can perform maintenance operations without the need for a ladder or other similar equipment. It should be understood that the greater the height of the camera array then the greater the area of the grid that may be viewed by the camera array. The camera array may comprise one or more cameras. The camera array may comprise one or more 3D cameras. The camera array may further comprise one or more lighting elements to illuminate the area in which the end effector of a picking station will operate. A camera array, or one or more cameras of a camera array, may be movable or rotated to be able to view a particular grid location, as required. If the camera array comprises one lighting elements then these may be movable or rotated to illuminate a particular grid location, as required.

The or each camera unit 200 is in communication with a remote computer device 130 such that the images captured by the camera array can be processed and the data extracted from the images then used by a robotic picking station in the picking process. For example, the image may be processed to generate an organised point cloud such that grasp points can be determined, as is disclosed in the Applicant's co-pending application WO 2019/097004. The or each camera unit may also comprise a computer device 130 which is configured to perform some or all of the image processing work. As discussed above, each of the robotic picking stations may comprise a computer device 130. The processing of the images captured from the camera array may be processed to generate commands that determine the movement of the robotic arm in the picking process using one or more of the computer devices 130. The processing of the camera images may be distributed across one or more of the computer devices. The camera array may comprise one or more RGB cameras, the output of which can be sent to a computer device for processing. Alternatively, or in addition, the camera array may comprise one or more depth cameras, which can generate a three dimensional image of the interior of a container. The output of the depth camera(s) can be sent to a computer device for processing.

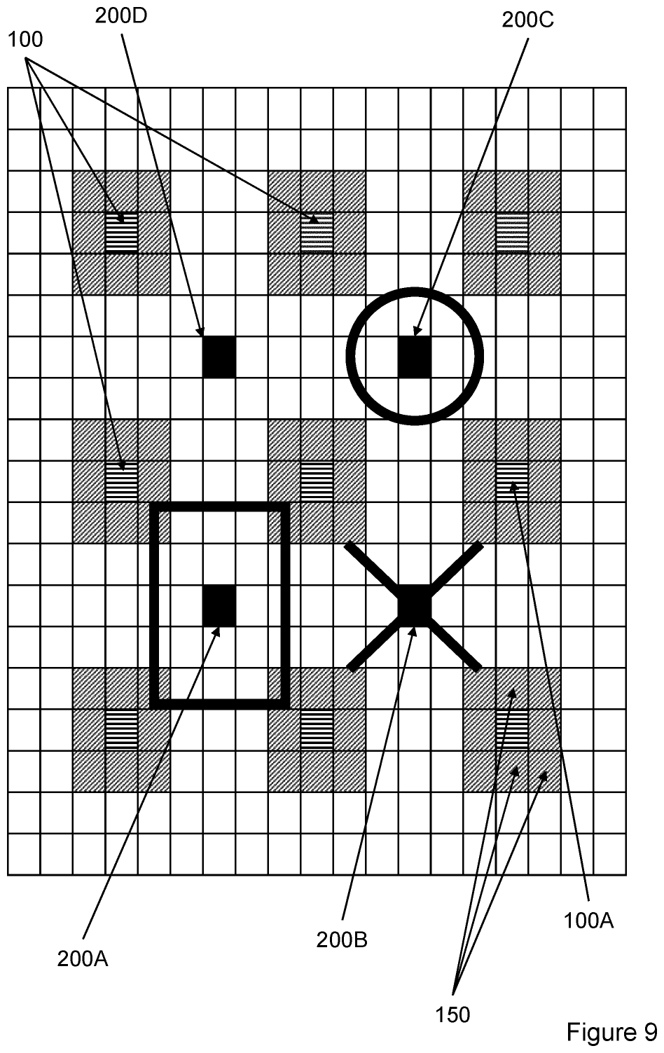

FIG. 9 shows a schematic depiction of an overhead view of the grid of a storage system similar to that described above. The grid comprises a plurality of robotic picking stations 100, each of which are received within a single grid location. Each of the robotic picking stations is surrounded by eight picking locations 150, such that each robotic picking station can be defined by a 3×3 cell of the grid. A plurality of camera units 200 are provided on the grid, with each camera unit occupying a single grid cell. A camera array may be configured to be able to view a number of different picking stations. By way of example, FIG. 9 shows camera unit 200A, the camera array of which has a rectangular shape, camera unit 200B, the camera array of which has a cruciform shape, such that the arms of the camera array are at an angle of substantially 45° to the X and Y direction of the grid, camera unit 200C, the camera array of which has a circular shape, and camera unit 200D, the camera array of which is received entirely within the footprint of the grid cell within which the camera unit is installed. In this case, the camera array of camera unit 200D has a size and shape which is substantially identical to that of the grid cell but it should be understood that it could have a non-rectangular shape and/or it may have a smaller area than the grid cell. It should be understood that other camera array shapes are possible, for example, circular, elliptical circle, etc., or that the camera arrays may be rotated relative to the grid structure. The camera arrays may have complex shapes, for example circular or elliptical lobes received at the end of linear arms, or irregular shapes. It should be understood that the exact shape of the camera array is not critical to the present disclosure.

FIG. 8 shows one camera unit 200 mounted on the grid in-between two robotic picking stations. It should be understood that the camera unit 200 may be configured such that the cameras in the camera array 230 are able to view all of the picking locations 150 of both of the robotic picking stations. Similarly, the camera units and the picking stations may be located and configured such that one camera unit may be able to view a greater number of picking stations, for example three or four picking stations. Referring to FIG. 9, camera unit 200A may be configured such that it can view each of the picking locations of the four picking stations to which it is closest.

In an alternative arrangement, a picking station may be located such that all of the associated picking locations cannot be viewed by a single camera. In such a case, images from two or more camera units will be processed to enable the picking station to control the robotic arm appropriately. For example, referring to FIG. 9, camera units 200C and 200B may be used to monitor the picking locations of picking station 100A.

FIG. 9 shows a grid configuration in which each picking station occupies a single grid cell and the surrounding eight grid cells are allocated to that picking station as picking locations. There are lanes of grid locations between each of the picking stations and the associated picking locations that are not allocated for use by a picking station or a picking station and thus are available for use as storage locations for product. It is been found that having these lanes three grid locations wide provides an advantageous balance between the number of pick stations which can be provided on the grid without causing unacceptable levels of bot congestion on the grid. As can be seen from FIG. 9, in the situation where a camera unit is to be located between two picking stations it has been found that a preferred location for a camera unit is in the centre of the lane of storage grid locations between adjacent pick stations, in both the X and the Y direction.

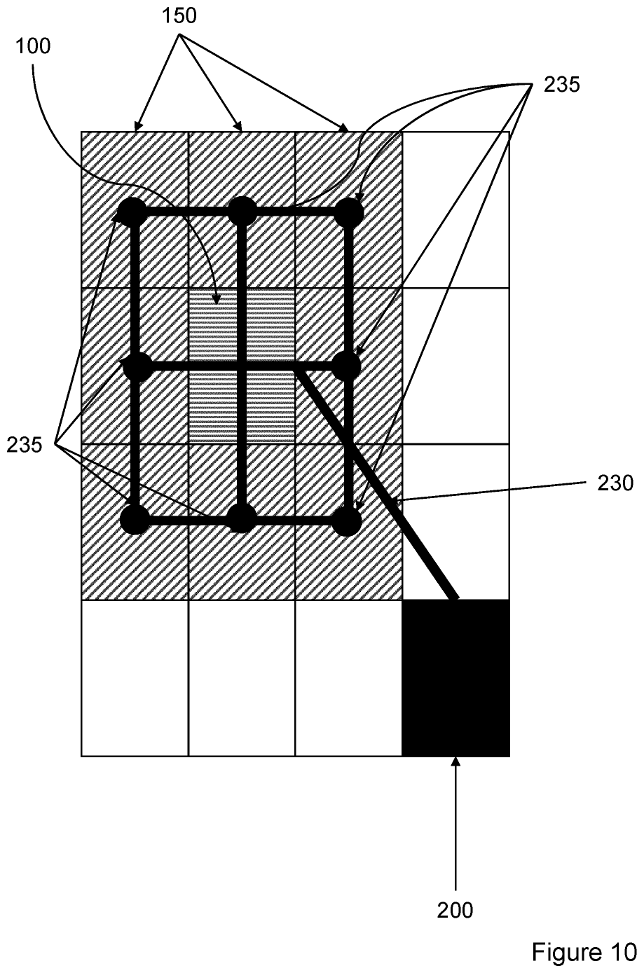

FIG. 10 shows a schematic depiction of a further example of a camera array 230 that may be used with a camera unit according to the present disclosure. FIG. 10 shows an overhead view of an automated storage system which comprises an on-grid robotic picking station 100, which is surrounded by eight picking locations 150. A camera unit 200 is located near to the picking station and comprises a camera array 230 which comprises eight cameras 235, such that a respective camera is located above each of the picking locations 150. The camera array may be mechanically coupled to the camera array support of one or more further camera arrays so as to reduce the vibration of the camera array. In the arrangement shown in FIG. 10, a single camera unit 200 is provided on the grid for each of the robotic picking stations. In such an arrangement it has been found effective to locate the camera unit in a grid cell that is diagonally displaced from one of the corner picking locations of the robotic picking station, as is shown in FIG. 10.

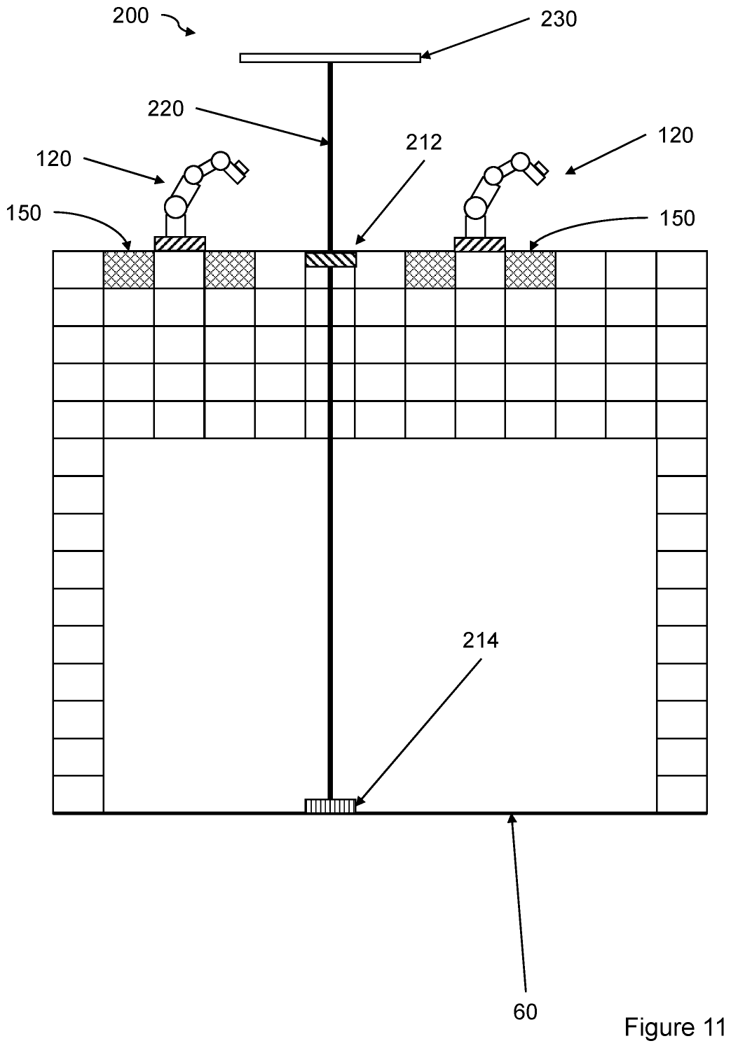

FIG. 11 shows a schematic depiction of a part of a storage system similar to that described above with reference to FIG. 8. FIG. 11 shows a floor 60 beneath the storage system. FIG. 11 also shows that the camera array support 220 extends beneath the surface of the grid and down to the floor 60, where a base 214 connects the camera array support to the floor. The camera unit plinth 210, as described above with reference to FIG. 8, may be retained. Alternatively, it may be replaced with a blanking plate 212 which blocks off the grid cell within which the camera unit is received. The floor 60 may be a mezzanine level within the warehouse or it may be the ground floor to which the storage and retrieval system is attached.

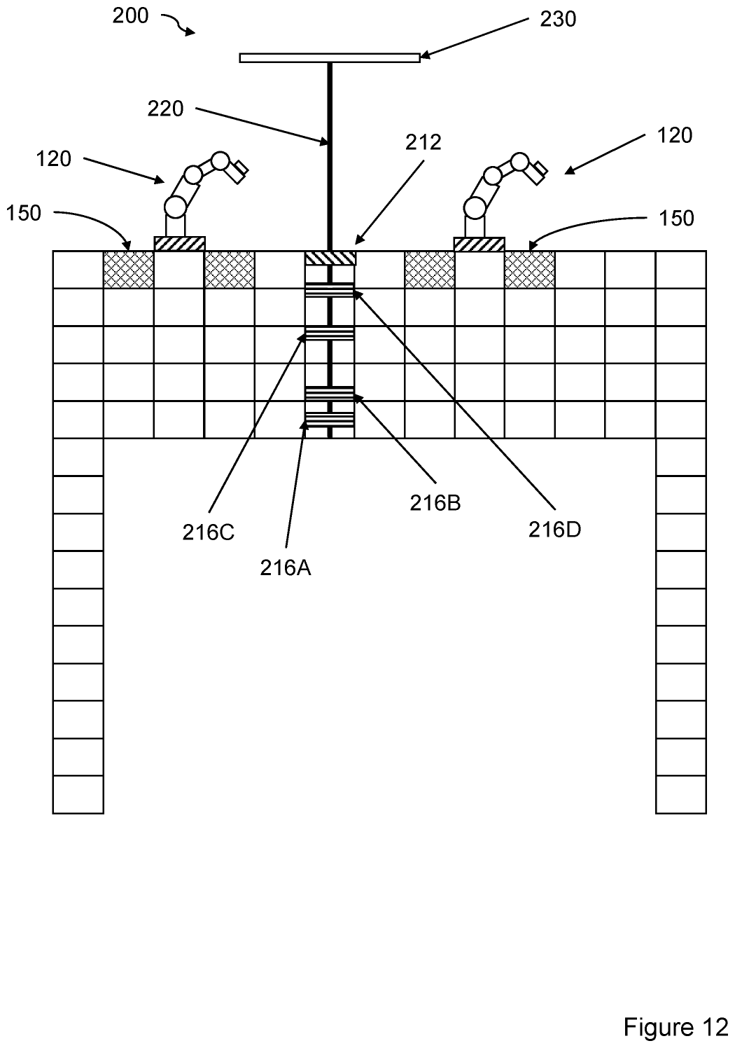

FIG. 12 shows a schematic depiction of a part of a storage system similar to that described above with reference to FIG. 8. FIG. 12 shows that the camera array support 220 extends beneath the surface of the grid and that one or more support attachments 216 may be provided to attach the camera array support to one or more of the upright members 3 and/or one or more of the horizontal members 5, 7 of the grid structure. The camera unit plinth 210, as described above with reference to FIG. 8, may be retained. Alternatively, it may be replaced with a blanking plate 212 which blocks off the grid cell within which the camera unit is received. The attachment of the camera array support in this manner may reduce the vibration of the camera array.

For example, a support attachment 216A may be coupled to one or more of the upright members of a grid cell. In a further example, a support attachment 216B may be connected on top of one or more of the horizontal members 5, 7 of a grid cell. The support attachment 216B may be further connected to one or more of the upright members of that grid cell. In an alternative, a support attachment 216C may be connected to the underside of one or more of the horizontal members 5, 7 of a grid cell. The support attachment 216C may be further connected to one or more of the upright members of that grid cell. In a yet further example, a support attachment may be connected to both the top and the underside of the one or more of the horizontal members 5, 7 of a grid cell. The support attachment 216D may be further connected to one or more of the upright members of the vertically adjoining grid cells. It should be understood that it is preferred that the support attachments do not extend into the space of horizontally adjacent grid cells as this could interfere with the storage and retrieval of containers.

It should be understood that it is possible to combine the arrangements described above with respect to FIGS. 11 & 12, such that a camera array support 220 may be connected to a floor 60 using base 214 and that the upper part of the camera array support 220 may be connected to one or more of the upright members 3 and/or one or more of the horizontal members 5, 7 of the grid structure using one or more support attachments 216. The use of the base 214 and the support attachment(s) 216 to secure the camera array support may reduce the vibration of the camera array.

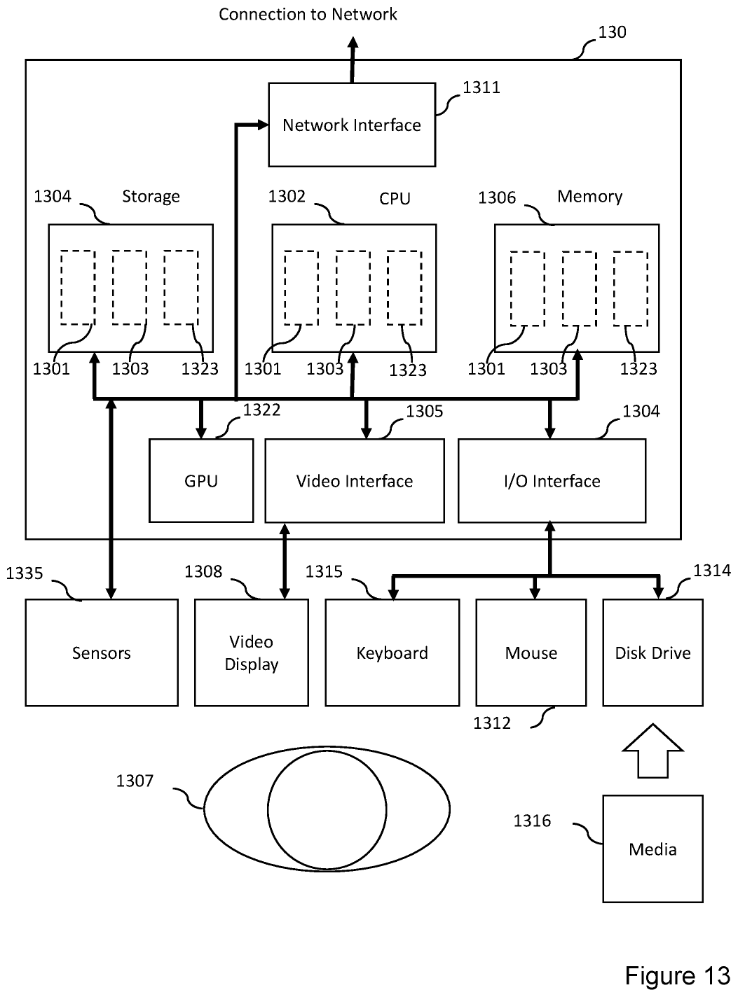

A suitably configured computer device 130, and associated communications networks, devices, software and firmware may provide a platform for enabling one or more embodiments as described above. By way of example, FIG. 13 shows a schematic depiction of a computer device 130 that may include a central processing unit (“CPU”) 1302 connected to a storage unit 1314 and to a random access memory 1306. The CPU 1302 may process an operating system 1301, application program 1303, and data 1323. The operating system 1301, application program 1303, and data 1323 may be stored in storage unit 1314 and loaded into memory 1306, as may be required. Computer device 130 may further include a graphics processing unit (GPU) 1322 which is operatively connected to CPU 1302 and to memory 1306 to offload intensive image processing calculations from CPU 1302 and run these calculations in parallel with CPU 1302. An operator 1307 may interact with the computer device 130 using a video display 1308 connected by a video interface 1305, and various input/output devices such as a keyboard 1315, mouse 1312, and disk drive or solid state drive 1314 connected by an I/O interface 1304. In known manner, the mouse 1312 may be configured to control movement of a cursor in the video display 1308, and to operate various graphical user interface (GUI) controls appearing in the video display 1308 with a mouse button. The disk drive or solid state drive 1314 may be configured to accept computer readable media 1316. The computer device 130 may form part of a network via a network interface 1311, allowing the computer device 130 to communicate with other suitably configured data processing systems (not shown). One or more different types of sensors 1335 may be used to receive input from various sources.

The present system and method may be practiced on virtually any manner of computer device including a desktop computer, laptop computer, tablet computer or wireless handheld. The present system and method may also be implemented as a computer-readable/useable medium that includes computer program code to enable one or more computer devices to implement each of the various process steps in a method in accordance with the present disclosure. In case of more than computer devices performing the entire operation, the computer devices are networked to distribute the various steps of the operation. It is understood that the terms computer-readable medium or computer useable medium comprises one or more of any type of physical embodiment of the program code. In particular, the computer-readable/useable medium can comprise program code embodied on one or more portable storage articles of manufacture (e.g. an optical disc, a magnetic disk, a tape, etc.), on one or more data storage portioned of a computing device, such as memory associated with a computer and/or a storage system.

In further aspects, the disclosure provides systems, devices, methods, and computer programming products, including non-transient machine-readable instruction sets, for use in implementing such methods and enabling the functionality described previously.

In this document, the language “movement in the n-direction” (and related wording), where n is one of x, y and z, is intended to mean movement substantially along or parallel to the n-axis, in either direction (i.e. towards the positive end of the n-axis or towards the negative end of the n-axis). In this document, the word “connect” and its derivatives are intended to include the possibilities of direct and indirection connection. For example, “x is connected to y” is intended to include the possibility that x is directly connected to y, with no intervening components, and the possibility that x is indirectly connected to y, with one or more intervening components. Where a direct connection is intended, the words “directly connected”, “direct connection” or similar will be used. Similarly, the word “support” and its derivatives are intended to include the possibilities of direct and indirect contact. For example, “x supports y” is intended to include the possibility that x directly supports and directly contacts y, with no intervening components, and the possibility that x indirectly supports y, with one or more intervening components contacting x and/or y. The word “mount” and its derivatives are intended to include the possibility of direct and indirect mounting. For example, “x is mounted on y” is intended to include the possibility that x is directly mounted on y, with no intervening components, and the possibility that x is indirectly mounted on y, with one or more intervening components. In this document, the word “comprise” and its derivatives are intended to have an inclusive rather than an exclusive meaning. For example, “x comprises y” is intended to include the possibilities that x includes one and only one y, multiple y's, or one or more y's and one or more other elements. Where an exclusive meaning is intended, the language “x is composed of y” will be used, meaning that x includes only y and nothing else. In this document, “controller” is intended to include any hardware which is suitable for controlling (e.g. providing instructions to) one or more other components. For example, a processor equipped with one or more memories and appropriate software to process data relating to a component or components and send appropriate instructions to the component(s) to enable the component(s) to perform its/their intended function(s).

In one respect, the present disclosure concerns a camera unit provided for use with a cubic automated storage and retrieval system. The camera unit is configured to operate on the grid of the storage and retrieval system such that is received within a single grid cell of the storage and retrieval system. The camera unit is mounted to the framework of the storage and retrieval system and comprises a camera array comprising one or more cameras. The camera unit is arranged such that the camera array may view one or more picking station located on the grid of the storage and retrieval system

1-20. (canceled)

21. A camera unit configured to be mounted to a grid-based storage system, the camera unit comprising:
a mount for mounting the camera unit to the storage system, such that the camera unit is received within a grid cell of the storage system;
a camera array including one or more cameras; and
a camera array support, a first end of which is coupled to the mount and a second end of which is coupled to the camera array.

22. A camera unit according to claim 21, wherein the camera unit comprises:
a computing device including one or more processors and one or more data storage units, the computing device being configured to, in use, process images captured by the camera array.

23. A camera unit according to claim 21, wherein the camera unit is communicably connected to a remote computing device, the remote computing device comprising:
one or more processors and one or more data storage units, and being configured to, in use, process images captured by the camera array.

24. A camera unit according to claim 21, wherein the camera array comprises:
one or more lighting elements.

25. A camera unit according to claim 21, wherein one or more of the cameras are configured to be rotated or moved within the camera array.

26. A camera unit according to claim 21, wherein the camera array is configured to rotate or move relative to the camera array support.

27. A camera unit according to claim 21, wherein the camera unit is configured to be retracted below a surface of the grid.

28. A camera unit according to claim 21, wherein the mount is configured to be connected to one or more framework members of the storage system.

29. A camera unit according to claim 28, wherein the mount is configured to be received below a top surface of the storage system.

30. A camera unit according to claim 28, wherein the mount is configured to be connected to one or more vertical framework members of the storage system and/or one or more horizontal framework members of the storage system.

31. A camera unit according to claim 28, wherein the camera unit comprises:
one or more mounts configured to be connected to one or more framework members of the storage system below a top surface of the storage system.

32. A camera unit according to claim 21, wherein the mount is configured to be connected to a floor of the storage system.

33. A camera unit according to claim 21, in combination with a storage system, the storage system comprising:
a first set of tracks extending in a first direction;
a second set of tracks extending in a second direction transverse to the first direction, to form a grid comprising a plurality of grid cells;
a framework structure on which the first set of tracks and the second set of tracks are received, and configured to store t a stack of containers below each of the plurality of grid cells; and
one or more of the camera units.

34. A storage system according to claim 33, wherein the storage system comprises:
a plurality of load-handling devices configured for lifting and moving containers stacked in stacks within the storage system, each of the load-handling devices being configured to move on the tracks above the stacks of containers.

35. A storage system according to claim 33, wherein the storage system comprises:
one or more regions in which the stacks beneath the grid have a reduced height and where one or more camera units are located above one of the regions.

36. A storage system according to claim 33, wherein each of one or more of the camera units is configured such that it can be lowered beneath the grid surface.

37. A storage system according to claim 33, wherein the storage system comprises:
one or more robotic picking stations received on the surface of the grid.

38. A storage system according to claim 37, wherein a camera unit is configured to view one or more of plurality of robotic picking stations.

39. A storage system according to claim 37, wherein:
a robotic picking station is received within a single grid cell of the storage system;
each of the grid cells surrounding the grid cell including the robotic picking station being designated as a picking location; and
a camera unit is configured to view each of the picking locations.

40. A storage system according to claim 38, wherein the camera unit comprises:
a plurality of cameras such that there is one camera for each picking location.
